(19) United States
(12) Patent Application Publication
(10) Pub. No.: US 2009/0119928 A1
(43) Pub. Date: May 14, 2009

(54) DUAL BLADE TRIMMER WITH SLIDE-OUT BLADE ASSEMBLY

(76) Inventor: WILLI KWOK YIU LEE, Dong Guan City (CN)

Correspondence Address: Lawrence Cruz;Conair Corporation, One Cummings Point Road, STAMFORD, CT, 06902, US

(21) Appl. No.: 12/267,119

(22) Filed: Nov. 7, 2008

Related U.S. Application Data
(60) Provisional application No. 60/986,446, filed on Nov. 8, 2007.

(51) Int. Cl. B26B 19/00; B26B 15/00

(52) U.S. Cl. 30/225; 30/228

(57) ABSTRACT

A hair trimmer 1 has a lower housing 2 with a battery or battery set 9, a motor 7, a first blade driver 10 and a first trimmer blade 11. A first blade driver 10 drives both the first trimmer blade 11 and a first lever 12. The first lever 12 is used to drive a second blade assembly 8 for fine trimming. The upper housing 4 includes a second blade assembly 8 located on a sliding platform 14 in the upper housing 4 and is driven by the first lever 12 through its blade driver 15. The two housings and cover 2, 3, 4 are moveable between engaged and disengaged positions with their respective drive assemblies for being selectively driven by the motor so that either of the blade assemblies 6,8 are activated, respectively.

### CROSS-REFERENCE TO RELATED APPLICATIONS

This application is related to and claims priority from earlier filed U.S. Provisional Application No. 60/986,446 file 8 Nov. 2007.

### BACKGROUND OF THE INVENTION

1. Field of the Invention

The present invention relates to hair trimmers and, more particularly, to multi-purpose hair trimmers having two separate cutting assemblies, each adapted for a specific purpose.

2. Description of Related Art

Various known trimmers exist with a wider blade assembly for clipping hair on the scalp or hair on a beard, and a more narrow blade assembly for accurately trimming contours of the sideburns, beard or edges of the hair on the scalp. Such known trimmers have cumbersome sliding mechanisms for actuating or moving one of the blades into operational position. These trimmers are cumbersome and lack durability, and are subject to jamming or corrosion from hair, moisture, and shaving products entering crevices between movable parts.

It is desirable to provide a multi-purpose trimmer with two blade assemblies that can be conveniently switched between modes and that is durable.

### OBJECTS OF THE PRESENT INVENTION

It is an object of the present invention to provide a multi-purpose trimmer with two blade assemblies that can be conveniently switched between modes and that is durable.

These and other objects are achieved by the present invention.

### BRIEF DESCRIPTION OF THE DRAWINGS

FIG. 1A is a top, perspective view of a trimmer according to the present invention shown in a first position.

FIG. 1B is a top, perspective view of a trimmer according to the present invention shown in a second position.

FIG. 2A is a partial, bottom, perspective view of a trimmer according to the present invention.

FIG. 2B is a partial, side, cross-sectional view of a trimmer according to the present invention.

FIG. 3A is a partial, top, perspective view of a trimmer according to the present invention shown in a first position.

FIG. 3B is a partial, side, cross-sectional view of a trimmer according to the present invention.

FIG. 4A is a partial, side, cross-sectional view of a trimmer according to the present invention shown in a first position.

FIG. 4A is a partial, side, cross-sectional view of a trimmer according to the present invention shown in a second position.

FIG. 5A is a partial, top, perspective view of a trimmer according to the present invention shown in a first position.

FIG. 5B is a partial, top, perspective view of a trimmer according to the present invention shown in a second position.

FIG. 6A is a side, cross-sectional view of a trimmer according to the present invention shown in a first position.

FIG. 6B is a side, cross-sectional view of a trimmer according to the present invention shown in a second position.

### DETAILED DESCRIPTION OF THE PREFERRED EMBODIMENTS OF THE INVENTION

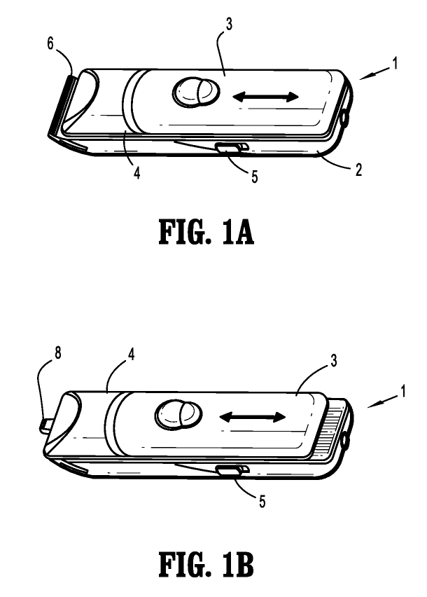

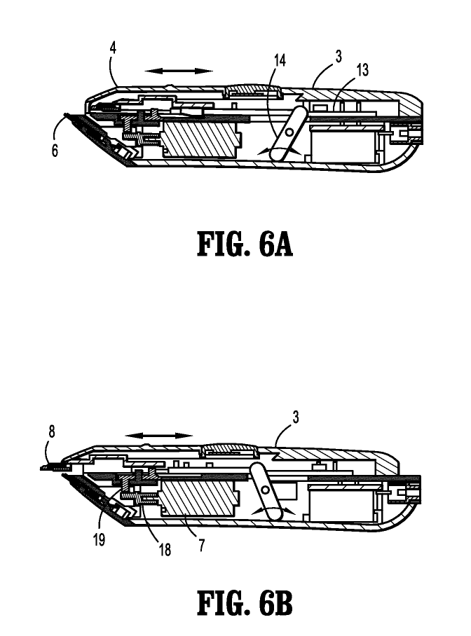

Referring to FIG. 1-6, a first embodiment of the present invention includes a trimmer 1 having a housing divided into two sections, a lower housing 2 and a top cover 3 mounted to an upper housing 4. The lower housing 2, top cover 3, and upper housing 4 house elements that are constructed as and operated like a conventional hair trimmer with an On/Off switch 5 and an operational first blade assembly 6 driven by an electric motor 7. The upper housing 4 houses and supports a second blade assembly 8 which is idle and inactive when in normal trimming position as shown in FIG. 1A, but extended and active when in the fine trimming position as shown in FIG. 1B. When the top cover 3 is pushed forward and locked in the position shown in FIG. 1B, the second blade assembly 8 becomes operationally engaged with the motor 7 in the lower housing 2 for cutting with the second blade assembly 8. The second blade assembly 8 preferably has a narrower cutting blade width than the first blade assembly 6 for shaping and trimming accurately for such uses as sideburn and beard trimming, or cutting of body hair in locations other than the scalp. Both blade assemblies 6 and 8 comprise conventional trimmer assemblies having a blade with a stationary component and a reciprocating component to shear hair.

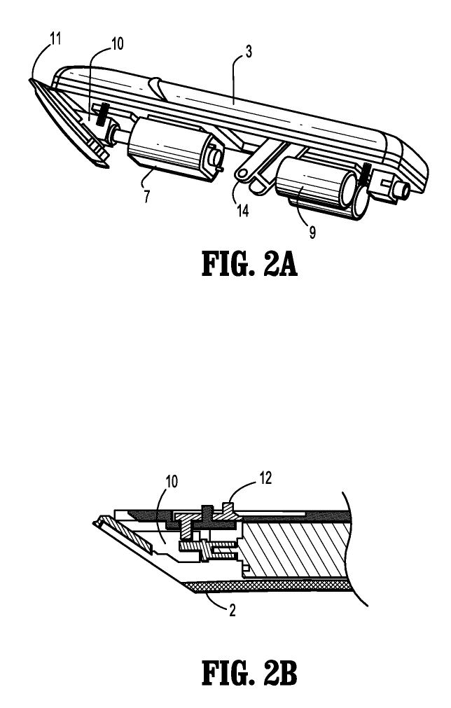

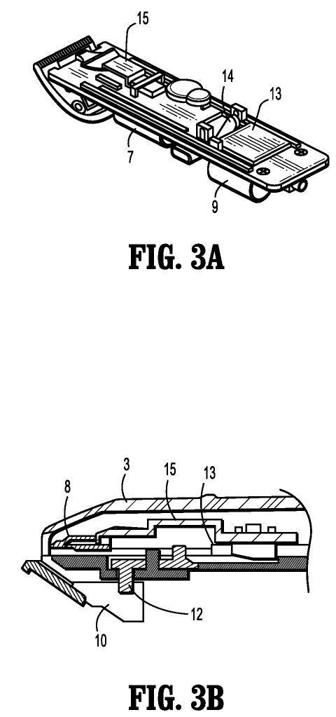

The trimmer 1 is constructed generally as follows. The lower housing 2 comprises what resembles a conventional trimmer and includes a battery or battery set 9, a motor 7, a first blade driver 10 and a first trimmer blade 11 as shown in FIGS. 2A and 2B. The first blade driver 10 drives both the first trimmer blade 11 and a first lever 12. The first lever 12 is used to drive the second blade assembly 8 for fine trimming at the sliding platform 13 in the upper housing 4. The upper housing 4 which comprises the second blade assembly 8 is located on the sliding platform 14 in the upper housing 4 and is driven by the first lever 12 through its blade driver 15 as shown in FIGS. 3A and 3B. The first lever 12 is fixed in the upper housing 4 while blade driver 15 is fixed on sliding platform 13. The two housings and cover 2, 3, 4 are moveable between engaged and disengaged positions with their respective drive assemblies for being selectively driven by the motor.

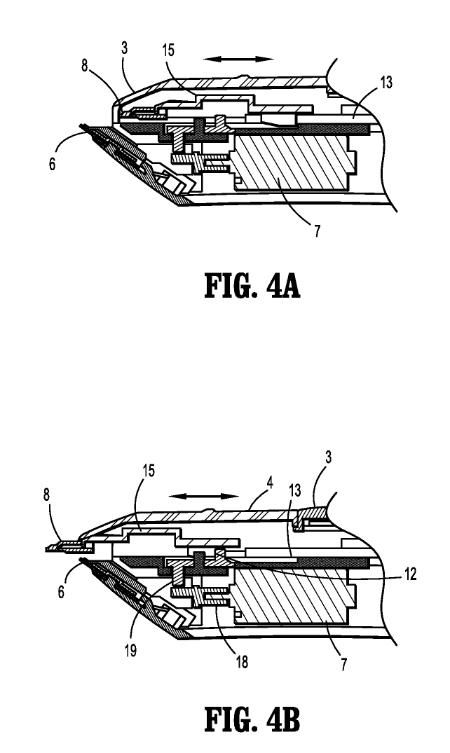

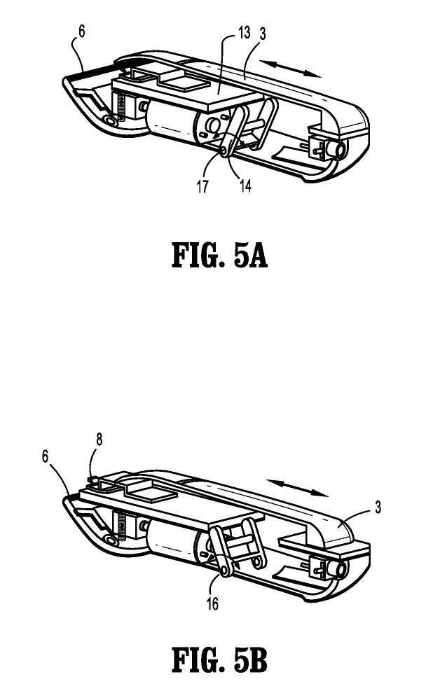

The connection between the lever 12 and the blade driver 15 is off while the top cover 3 is at the normal position shown in FIG. 1A. They are engaged while the top cover 3 and the sliding platform 13 are moved forward. As shown in FIGS. 4A and 4B, movement of the sliding platform 13 is controlled by the user through a cooperation of the top cover 3 and a lever system 14 as shown in FIGS. 5A and 5B. When the user pushes the top cover 3 forward, a tap of the top cover pushes the lever system 14, with a fulcrum 16 at the lower housing and connected with the sliding platform 13 at a point 17. The lever system 14 is designed in such a way that the movement of the sliding platform 13 is greater in magnitude than the movement of the top cover 3. When the second blade assembly 8 is de-activated, it is retracted into the upper housing 4.

An output shaft 18 extending from the electric motor 7 is rotatably driven by the motor 7 and drives one or more gears 19 which cause the first blade driver 10 and the first lever 12 to move, thereby driving the first blade assembly 6. In the first position of FIG. 1A and of FIG. 4A, the first blade assembly 6 is driven and the second blade assembly 8 is inactive while the second blade driver 15 is not engaged with the lever 12. In the second position of FIG. 1B and of FIG. 4B, the top cover 3, second blade driver 15, and second drive assembly 8 are slid forward so that the second blade driver 15 now engages the lever 12, thereby causing the second blade assembly 8 to be driven.

While the preferred embodiments have been shown and described, various modifications can be made without departing from the scope of the present invention.

What is claimed is:

1. A hair trimmer comprising
a housing comprising an upper housing, a lower housing, and a cover plate, said cover plate being slideably mounted to said lower housing to selectively be moved linearly relative to said lower housing;
an electric motor;
a first blade assembly comprising a first blade having a first blade width and being adapted to be driven by said electric motor when said cover plate is in a first position; and
a second blade assembly comprising a second blade having a second blade width different from said first width and being adapted to be driven by said electric motor when said cover plate is in a second position, and adapted to be prevented from being driven when said cover plate is in said first position.

2. A hair trimmer according to claim 1, further comprising
a first mechanical linkage adapted to drive said first blade assembly and a lever when said cover plate is in said first position; and
a second mechanical linkage adapted to engage said lever when said cover plate is in said second position, said second mechanical linkage being in communication with said second blade assembly and causing it to be driven.

3. A hair trimmer according to claim 1, further comprising
a battery housed in said trimmer for providing electrical power to said motor.

4. A hair trimmer according to claim 1, wherein
said second blade assembly is retracted into said upper housing when said cover plate is in said first position and said second blade assembly is extended out of said upper housing when said cover plate is in said second position.
